(19) United States
(12) Patent Application Publication
(10) Pub. No.: US 2007/0230925 A1
(43) Pub. Date: Oct. 4, 2007

(54) Low speed driving control device of DC motor and control method thereof

(75) Inventor: Ho-bin Hwang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/700,081

(22) Filed: Jan. 31, 2007

(30) Foreign Application Priority Data
Mar. 29, 2006 (KR) 2006-0028500

(51) Int. Cl. H02P 7/06

(52) U.S. Cl. 388/803

(57) ABSTRACT

A low speed driving control device of a DC motor and a control method thereof are provided. The low speed driving control device of a DC motor includes a first speed controller which controls the speed of the DC motor according to a control period, based on a feedback information about current speed of the DC motor, a second speed controller which controls the speed of the DC motor according to a voltage table, and a switching controller which switches between the first and the second speed controllers according to a position change of an encoder which is connected with the DC motor. Accordingly, by using a low resolution encoder, a high quality driving can be provided at a low price.

### CROSS-REFERENCE TO RELATED APPLICATION

This application claims the benefit under 35 U.S.C. § 119(a) of Korean Patent Application No. 2006-0028500, filed Mar. 29, 2006 in the Korean Intellectual Property Office, the entire disclosure of which is hereby incorporated by reference.

### BACKGROUND OF THE INVENTION

1. Field of the Invention

The present invention relates to an apparatus for and a method of controlling low speed driving of a DC motor. More particularly, the present invention relates to an apparatus for and a method of controlling low speed driving of a DC motor, which is capable of providing reduced speed ripples using a low resolution encoder.

2. Description of the Related Art

FIG. 1 is a block diagram of a conventional DC motor driving apparatus. FIGS. 2A and 2B show the structure of a conventional DC motor driving apparatus.

Referring to FIG. 1, it is widely accepted to use a proportional-plus-integrate-plus-derivative (PID) controller 10 to control a DC motor 20. The PID controller 10 receives feedback of current speed of the DC motor 20 and controls the speed of the DC motor 20 with reference to a difference between the current speed and a reference speed.

Referring to FIG. 2A, the structure of a conventional DC motor driving apparatus will be explained briefly. As shown, an encoder 30 is connected to a rotary shaft 22 of the DC motor 20 so that the speed and the position of the DC motor 20 are informed through the encoder 30. Therefore, by constructing a closed loop to feedback the information about speed and position of the DC motor 20, the speed of the DC motor 20 can be controlled.

It is generally accepted that the PID controller 10 controls the DC motor 20 at time intervals below 2 ms. The speed control is only possible when the information about speed and position of the DC motor 20 varies at least once during the control period of 2 ms.

Therefore, a high resolution encoder 30 is required so that the information of the encoder 30 is varied within the period of 2 ms, especially when the DC motor 20 is driven at low speed. The ‘high resolution’ refers to one or more variation of speed and position information of the encoder 30 during the control period of 2 ms.

FIG. 2B shows an example of a high resolution encoder 30. As shown, a plurality of slots 34 is formed along a wheel 32 of the encoder 30. The PID controller 10 can control the DC motor 20 with higher accuracy as the number of slots 34 increases. However, the problem arises because high resolution encoder 30 is generally expensive.

Accordingly, while the accuracy of speed control with respect to the DC motor 20 can improve with the use of the high resolution encoder 30, there is also a drawback that the price increases. However, the severe speed ripples appear when the low resolution encoder is applied to the DC motor driving apparatus.

The speed control is possible up to

$$\frac{( \frac{1}{300 \times 4} )}{2 ms \times 60} = 20 rpm$$

with the encoder 30 of two channels having a 300 count-per-resolution (CPR) wheel coupled to the rotary shaft 22 of the DC motor 20. Also, the speed control is possible up to

$$\frac{( \frac{1}{30 \times 4} )}{2 ms \times 60} = 200 rpm$$

with the encoder 30 of two channels having a 30 CPR wheel 32.

Accordingly, there is a need for an improved system and method for controlling a DC motor 20 at a speed slower than 200 rpm, using an encoder 30 having a 30 CPR wheel 32.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a controller for use in a DC motor which is driven at such a low speed that the counts of position information of an encoder during a control period do not increase, the controller which is capable of driving a DC motor with reduced speed ripples, and without requiring a resolution of the encoder to be increased.

The above aspect is achieved when a low speed driving control device of a DC motor is provided. The low speed driving control device includes a first speed controller which receives feedback of current speed of a DC motor in accordance with a control period, and accordingly controls the speed of the DC motor; a second speed controller which controls the speed of the DC motor according to a voltage table; and a switching controller which switches between the first and the second speed controllers according to a position change of an encoder which is connected with the DC motor.

In an exemplary implementation, the first speed controller is a proportional-plus-integrate-plus-derivative (PID) controller.

In another exemplary implementation, the switching controller checks the position change of the encoder according to the control period, connects the first speed controller to the DC motor when there is a change in the position of the encoder, and connects the second speed controller to the DC motor when there is no change in the position of the encoder.

In a further exemplary implementation, the voltage table includes a speed of the DC motor according to a fixed position count of each target speed.

In a further exemplary implementation, the switching controller increments the fixed position count from an initial value “0” in every control period when there is no change in a count of encoder position information obtained according to the position change of the encoder, while the switching controller initializes the fixed position count when there is a change in the count of the encoder position information.

In a further exemplary implementation, the second speed controller, when connected to the DC motor by the switching controller, extracts a voltage corresponding to the fixed position count from the voltage table and accordingly controls the speed of the DC motor.

In a further exemplary implementation, the second speed controller determines a voltage V_{b} to control the DC motor by:

V_{b}=Vₚᵣₑᵥ+V_{cons}

where, Vₚᵣₑᵥ is a previous voltage of the DC motor, and V_{cons} is a voltage extracted from the voltage table.

The above aspect is also achieved by providing a low speed driving control method of a DC motor, which receives a feedback of current speed of the DC motor in accordance with a control period and accordingly controls the speed of the DC motor. It is determined whether there is any position change of an encoder connected with the DC motor according to the control period, and it is switched such that the feedback of the current speed is received to control the speed of the DC motor when there is no position change of the encoder, while the speed of the DC motor is controlled according to a voltage table when there is a position change of the encoder.

The voltage table includes a speed of the DC motor according to a fixed position count of each target speed.

During the switching, the fixed position count is incremented from an initial value “0” in every control period when there is no change in a count of encoder position information obtained according to the position change of the encoder, while the fixed position count is initialized when there is a change in the count of the encoder position information.

During the switching, a voltage corresponding to the fixed position count is extracted from the voltage table to control the speed of the DC motor when there is a position change of the encoder.

During the switching, a voltage V_{b} to control the DC motor is determined by:

V_{b}=Vₚᵣₑᵥ+V_{cons}

where, Vₚᵣₑᵥ is a previous voltage of the DC motor, and V_{cons} is a voltage extracted from the voltage table.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram of a conventional DC motor driving apparatus;

FIGS. 2A and 2B are views illustrating the structure of a conventional DC motor driving apparatus;

FIGS. 3A and 3B are views illustrating the structure of a low speed driving control device of a DC motor according to an exemplary embodiment of the present invention;

FIG. 4 is a block diagram of a low speed driving control device of a DC motor according to an exemplary embodiment of the present invention;

FIG. 5 is a view to explain operation of a low speed driving control device of a DC motor according to an exemplary embodiment of the present invention;

FIGS. 6A and 6B are views to explain performance of a low speed driving control device of a DC motor according to an exemplary embodiment of the present invention; and

FIG. 7 is a flowchart to explain a low speed driving control method of a DC motor according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

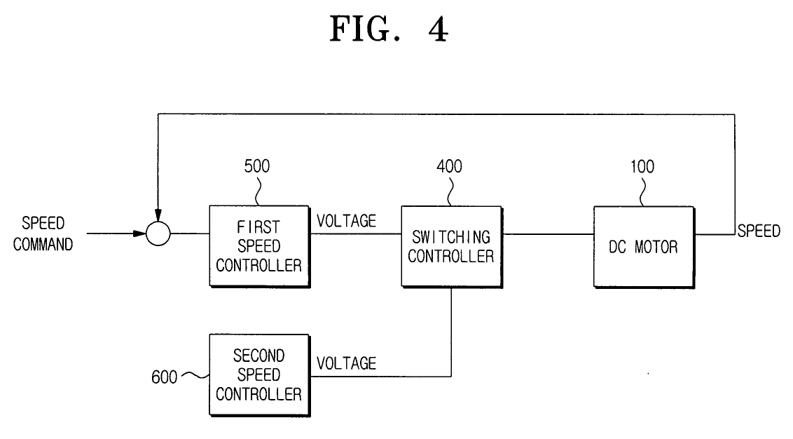

FIGS. 3A and 3B are views illustrating the structure of a low speed driving control device of a DC motor according to an exemplary embodiment of the present invention.

With reference to FIG. 3A, the structure of a low speed driving control device of a DC motor according to an exemplary embodiment of the present invention will be explained in detail.

A DC motor 100 and an encoder 200 are fixed to a fixation part 300. One end of the encoder 200 is connected with the fixation part 300, and approximately the middle part is connected with one end of a rotary shaft 110 of the DC motor 100.

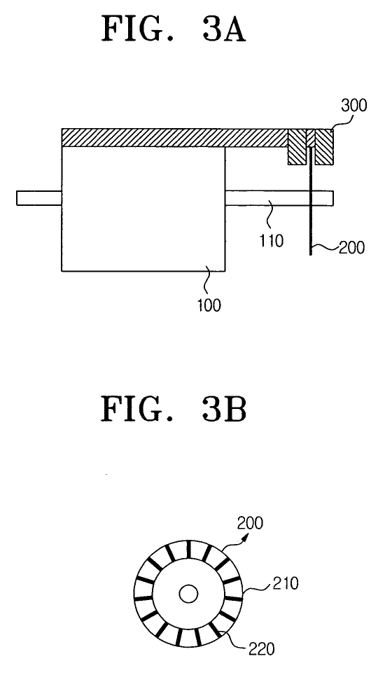

FIG. 3B is a sectional view showing an example of the encoder 200. For example, FIG. 3B shows a low resolution encoder 200 by way of an example. The encoder 200 of FIG. 3B has a relatively smaller number of slots 220 formed along the wheel 210 than the high resolution encoder 30 shown in FIG. 2B.

Because the low resolution encoder 200 according to an exemplary embodiment of the present invention is available at a lower price than the high resolution encoder 30, the price of low speed driving control device of DC motor can be reduced.

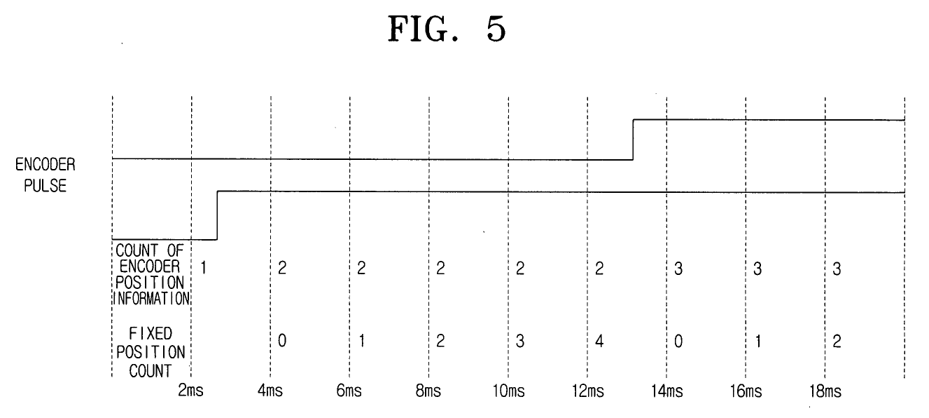

FIG. 4 is a block diagram of a low speed driving control device of a DC motor according to an exemplary embodiment of the present invention.

Referring to FIG. 4, a low speed driving control device according to an exemplary embodiment of the present invention may include a first speed controller 500, a second speed controller 600, a switching controller 400 and a DC motor 100.

In response to a speed command, the first speed controller 500 receives feedback of current speed of the DC motor 100 according to a predetermined control period and accordingly controls the speed of the DC motor 100. The predetermined control period may be 2 ms.

The first speed controller 500 may be a proportional-plus-integrate-plus-derivative (PID) which is widely used in the general DC motor driving devices.

The first speed controller 500 receives the feedback of current speed of the DC motor 100 in every control period, generates a first control signal by multiplying an error signal between a reference speed and the current speed by an appropriate proportional constant gain (KP), generates a second control signal by multiplying an integral of the error signal by an appropriate proportional constant gain (KI), and generates a third control signal by multiplying a differential of the error signal by an appropriate proportional constant gain (KD).

The first speed controller 500 then parallel-connects the control signals with each other to determine a voltage Vₐ to be applied to the DC motor 100. This can be expressed as:

Vₐ=(KP×speed error)+(KI×error integral)+(KD×error defferential) [Mathematical expression 1]

The first speed controller 500 controls the speed of the DC motor 100 according to the voltage Vₐ obtained by mathematical expression 1, and changes the previous voltage Vₚᵣₑᵥ of the DC motor 100 to a current voltage Vₐ. This can be expressed as:

Vₚᵣₑᵥ=Vₐ [Mathematical expression 2]

The PID controller explained above is generally used to control speed of the DC motor 100, but it does not achieve optimum speed ripples when the DC motor 100 is driven at a low speed.

When an encoder 200 having a 32 CPR wheel 210 is coupled to the rotary shaft 110 of the DC motor 100 and when two-channel encoder 200 is used, 128 counts of encoder position information increase in one rotation of the DC motor 100. The count of the encoder position information is automatically increased as the position of the encoder 200 varies. As this is well known in the art, explanation will be omitted for clarity and conciseness.

Because the control period of the DC motor 100 is 2 ms, the count of position information has to be increased at least by one in order to feedback speed information. Therefore, as 1/128 rotation occurs within 2 ms, control up to speed of (1/128 rotation)/2 ms=3.9 rpm=234 rpm, is possible.

In order to drive the DC motor 100 at a speed slower than 234 rpm and with optimum speed ripples, because there would be severe speed ripples with a general PID controller, the second speed controller 600 may control the DC motor 100 if the first speed controller 500 cannot control the DC motor 100.

The second speed controller 600 controls the speed of the DC motor 100 according to a voltage table. The voltage table may be constructed based on experimental data about increment or decrement in fixed position count for the respective target speeds. That is, the voltage table has an increment constant when the DC motor 100 rotates in a forward direction, while it has a decrement constant when the DC motor 100 rotates in backward direction. The voltage table may be pre-stored in a memory (not shown) in the form of a lookup table.

The fixed position count may be initially set to “0”, and increases when there are no changes in the count of encoder position information, while it is initialized when there is a change in the count of encoder position information.

Table 1 below shows some part of the voltage table used by the second speed controller 600 for the control of DC motor 100.

TABLE 1

| Fixed position count | 57 rpm | 104 rpm |
|---|---|---|
| 1 | +1400 | +2300 |
| 2 | +150 | +250 |
| 3 | +200 | +300 |
| 4 | +200 | +300 |
| . . . | . . . | . . . |

When the second speed controller 600 is connected with the DC motor 100 via the switching controller 400 explained below, the second speed controller 600 extracts a count corresponding to the current fixed position count from the voltage table and accordingly controls the speed of the DC motor 100.

The second speed controller 600 determines the voltage V_{b} to be supplied to the DC motor 100 to control the speed of the DC motor 100 according to the following:

V_{b}=Vₚᵣₑᵥ+V_{cons} [Mathematical expression 3]

where, Vₚᵣₑᵥ is a previous voltage of the DC motor 100, and V_{cons} is a voltage extracted by the second speed controller from the voltage table.

The second speed controller 600 then controls the speed of the DC motor 100 according to the voltage V_{b} obtained by mathematical expression 3, and changes the previous voltage Vₚᵣₑᵥ of the DC motor 100 to a currently-determined voltage V_{b}. This can be expressed as follows:

Vₚᵣₑᵥ=V_{b} [Mathematical expression 4]

The switching controller 400 switches such that one of the first speed controller 500 and the second speed controller 600 can control the DC motor 100 according to the change of position of the encoder 200 being connected with the DC motor 100.

The switching controller 400 determines whether the encoder 200 changes the position in every control period. When there is a change in the position of the encoder 200, the switching controller 400 switches to connect the first speed controller 500 to the DC motor 100, while it connects the second speed controller 600 to the DC motor 100 when there is no change in the position of the encoder 200.

More specifically, when the DC motor 100 is connected with the first speed controller 500 by the switching controller 400, the DC motor 100 is driven by the voltage Vₐ which is obtained by the first speed controller 500, while the DC motor 100 is driven by the voltage V_{b} which is obtained by the second speed controller 600 when the DC motor 100 is connected with the second speed controller 600.

The switching controller 400 increments by “1” the fixed position count from the initial value “0” when there is no change in the count of encoder position information in every control period, while the switching controller 400 initializes the current fixed position count to “0” when there is a change in the count of encoder position information.

Accordingly, the second speed controller 600 is able to determine a voltage to control the DC motor 100 based on the fixed position count varying in every control period.

The DC motor 100 is driven by the voltage V which is obtained by one of the first and second speed controllers 500, 600 being connected with the switching controller 400. The DC motor 100 feeds back current speed in accordance with a control period.

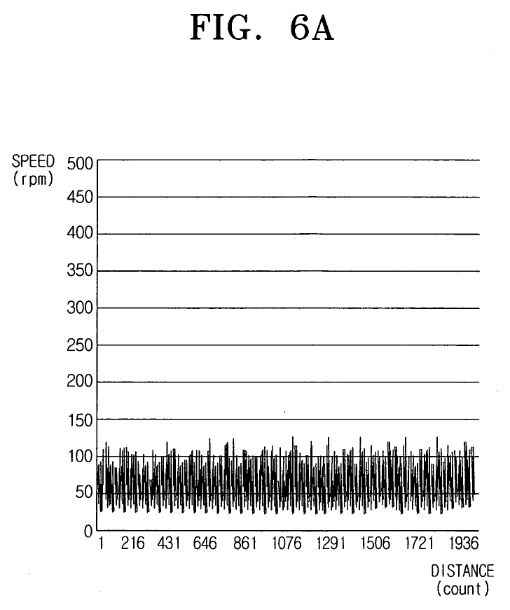

FIG. 5 illustrates the operation of a low speed driving control device of a DC motor according to an exemplary embodiment of the present invention.

Referring to FIG. 5, an example of using a low speed driving control device of a DC motor will be explained. When the DC motor 100 is driven in a forward direction at a speed of 57 rpm, the 2-channel encoder 200 has encoder pulses as shown in FIG. 5.

The switching controller 400 may check the position change of the encoder 200 based on the count of encoder position information in every control period which is, 2 ms, 4 ms, 6 ms, 8 ms, 10 ms, and so on. The count of encoder position information starts from the initial value “1”, increases to “2” at a point of 4 ms where the encoder pulse changes from “LOW” to “HIGH”, and increases to “3” at a point of 14 ms where the encoder pulse is recognized to be changed from “LOW” to “HIGH”.

The switching controller 400 may count the fixed position count based on the count of encoder position information. As shown, fixed position count starts from the initial value “0” at a point of 4 ms where the count of encoder position information increases from “1” to “2”, continuously increments by “1” in the following control periods of 6 ms, 8 ms, 10 ms, and 12 ms, and then initialized back to “0” at a point of 14 ms where the count of encoder position information increases from “2” to “3”. The fixed position count after the point of 16 ms again increments by “1” until the count of encoder position information changes.

Because there is a change in the count of encoder position information at the point of 4 ms, the switching controller 400 is switched such that the first speed controller 500 controls the DC motor 100. The voltage V supplied to the DC motor 100 may be computed by mathematical expression 1 at the first speed controller 500. The voltage Vₐ computed by the first speed controller 500 may be stored to the previous voltage Vₚᵣₑᵥ of the DC motor 100.

Because there is no change in the count of encoder position information at the point of 6 ms, the switching controller 400 switches such that the second speed controller 600 controls the DC motor 100. The voltage V finally supplied to the DC motor 100 may be computed by mathematical expression 3 at the second speed controller 600.

For example, because the fixed position count is “1” at the point of 6 ms, V_{cons}=+1400 mV is extracted from the voltage table of Table 1. As a result, voltage of V=V_{b}=Vₚᵣₑᵥ+1400 mV is supplied to the DC motor 100 at the point of 6 ms. The voltage V_{b} computed by the second speed controller 600 may be stored to the previous voltage Vₚᵣₑᵥ of the DC motor 100.

Because there is also no change in the count of encoder position information at the point of 8 ms, the switching controller 400 switches such that the second speed controller 600 continues controlling the DC motor 100. The fixed position count is “2”, and V_{cons}=+150 mV is extracted from voltage table 1, and the voltage V of Vₚᵣₑᵥ+150 mV is finally supplied to the DC motor 100.

Because there is no change in the count of encoder position information at the points of 10 ms and 12 ms, respectively, the switching controller 400 controls such that the second speed controller 600 continuously controls the DC motor 100, and the second speed controller 600 determines in the manner explained above the voltage V to be supplied to the DC motor 100.

There is a change in the count of encoder position information at the point of 14 ms. Therefore, the switching controller 400 switches such that the first speed controller 500 now controls the DC motor 100. As explained above, voltage to be supplied to the DC motor 100 is determined by one of the first and the second speed controllers 200, 300 according to the operation of the switching controller 400 in every control period.

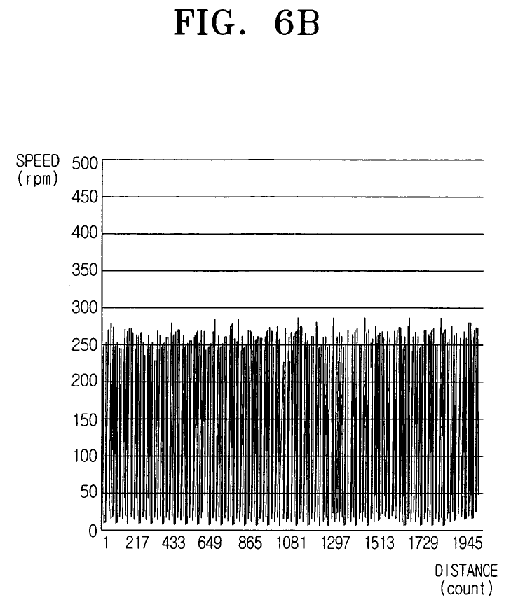

FIGS. 6A and 6B are views illustrating the performance of the low speed driving control device of a DC motor according to an exemplary embodiment of the present invention.

The speed ripples as shown in FIG. 6A appear when the speed of the DC motor 100 is controlled to vary according to the position changes of the encoder 200 by the switching controller 400 in every control period at intervals of 2 ms.

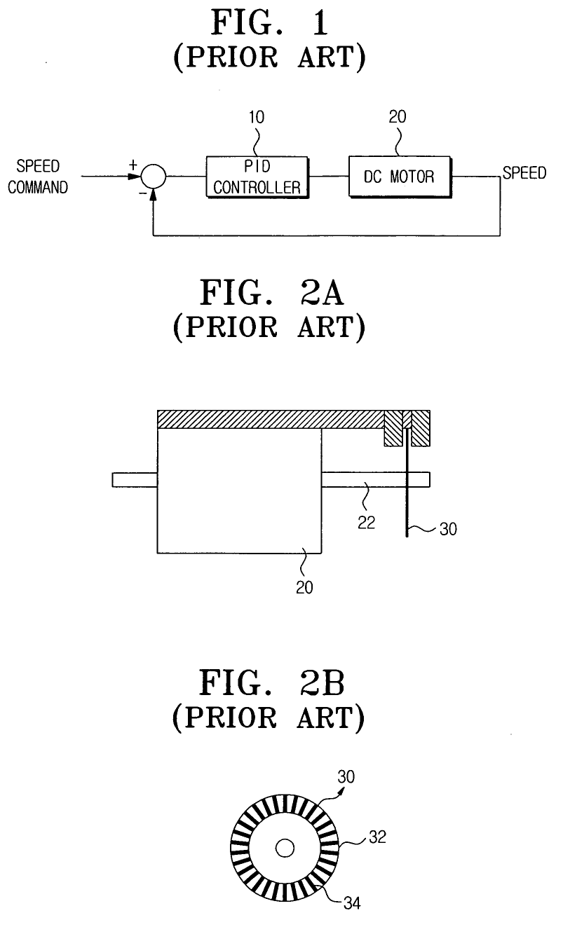

If the low-resolution encoder 200 as shown in FIG. 1 is employed in the conventional DC motor driving apparatus, the severe speed ripples appear as shown in FIG. 6B.

However, by selectively switching between the first and the second speed controllers 500, 600 according to the position change of the encoder 200 to control the driving of the DC motor 100, an exemplary embodiment of the present invention provides enhanced speed ripples compared to the conventional PID controlling.

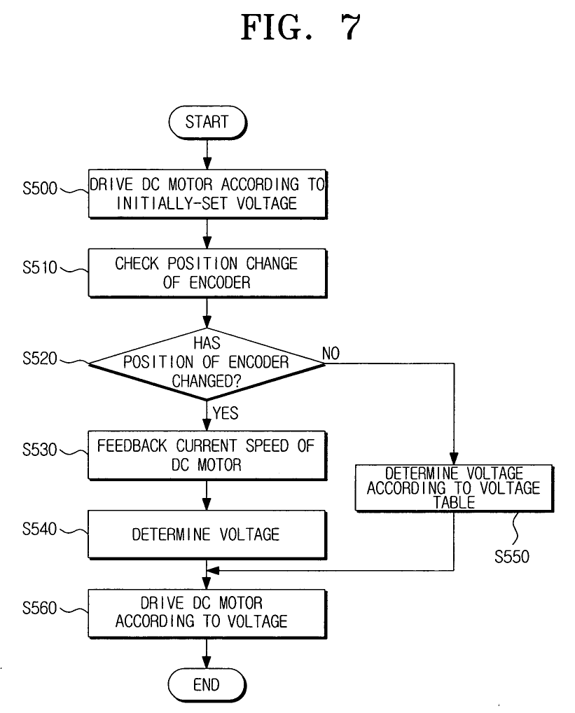

FIG. 7 is a flowchart illustrating a low speed driving control method of DC motor according to an exemplary embodiment of the present invention.

A low speed driving control method of DC motor according to an exemplary embodiment of the present invention will be explained with reference to FIGS. 1 to 7.

The DC motor 100 is driven by an initial value of voltage at step S500, and the switching controller 400 at step S510 checks whether there is any change in the position of the encoder 200 connected with the DC motor 100 at 2 ms time intervals, by counting the fixed position based on the count of encoder position information obtained according to the position change of the encoder 200.

When determining that there is a change in the position of the encoder 200 at step S520-Y, the switching controller 400 connects the DC motor 100 to the first speed controller 500. Accordingly, the DC motor 100 feeds back its current speed at step S530, and the first speed controller 500 determines a voltage to be supplied to the DC motor 100 based on the current speed of the DC motor 100 at step S540.

When determined by the switching controller 400 that there is no change in the position of the encoder 200 at step S520-N, the DC motor 100 is connected with the second speed controller 600. Accordingly, the second speed controller 600 determines a voltage to be supplied to the DC motor 100 based on the voltage which is extracted from a voltage table using the previous voltage and the current fixed position count of the DC motor 100 at step S550.

The DC motor 100 is driven by a voltage as determined by one of the first and the second speed controllers 500, 600 at step S560, and this operation repeats at 2 ms of time intervals.

As explained above, according to exemplary embodiments of the present invention, the DC motor 100 is controlled by selective switching based on a position change of an encoder 200 such that the DC motor 100 can be driven with reduced speed ripples, without having to increase the resolution of the encoder 200, when the DC motor is driven at a low speed that does not cause a count of encoder position information to increase within a control period. Because a low resolution encoder is used, a high quality driving with an economic price can be provided.

While the present invention has been shown and described with reference to certain exemplary embodiments thereof, it will be understood by those skilled in the art that various changes in the form and details may be made therein without departing from the spirit and scope of the invention as defined by the appended claims and their equivalents.

What is claimed is:

1. A low speed driving control device of a DC motor, comprising:
an encoder connected to a DC motor;
a first speed controller for receiving a current speed of the DC motor in a control period and controlling the speed of the DC motor;
a second speed controller for controlling the speed of the DC motor according to a voltage table; and
a switching controller for switching between the first and the second speed controllers according to a position change of the encoder.

2. The low speed driving control device of claim 1, wherein the first speed controller comprises a proportional-plus-integrate-plus-derivative (PID) controller.

3. The low speed driving control device of claim 1, wherein the switching controller determines the position change of the encoder according to the control period, connects the first speed controller to the DC motor when the position change occurs, and connects the second speed controller to the DC motor when the position change does not occur.

4. The low speed driving control device of claim 1, wherein the voltage table comprises a speed of the DC motor according to a fixed position count of each target speed.

5. The low speed driving control device of claim 4, wherein the switching controller increments the fixed position count from an initial value “0” in every control period when a count of encoder position information obtained according to the position change of the encoder does not change, and the switching controller initializes the fixed position count when the count of the encoder position information changes.

6. The low speed driving control device of claim 5, wherein the second speed controller, when connected to the DC motor by the switching controller, extracts a voltage corresponding to the fixed position count from the voltage table and accordingly controls the speed of the DC motor.

7. The low speed driving control device of claim 6, wherein the second speed controller determines a voltage V_{b} to control the DC motor by:
V_{b}=Vₚᵣₑᵥ+V_{cons}
where, Vₚᵣₑᵥ is a previous voltage of the DC motor, and V_{cons} is a voltage extracted from the voltage table.

8. A low speed driving control method for a DC motor, the control method comprising:
determining occurrence of a position change of an encoder connected with the DC motor according to a control period; and
if the position change does not occur, switching to receive the feedback of the current speed to control the speed of the DC motor, and if the position change occurs, controlling the speed of the DC motor according to a voltage table.

9. The low speed driving control method of claim 8, wherein the voltage table comprises a speed of the DC motor according to a fixed position count of each target speed.

10. The low speed driving control method of claim 9, wherein the switching comprises incrementing the fixed position count from an initial value “0” in every control period when there is no change in a count of encoder position information obtained according to the position change of the encoder, and initializing the fixed position count when there is a change in the count of the encoder position information.

11. The low speed driving control method of claim 10, wherein the switching comprises extracting a voltage corresponding to the fixed position count from the voltage table to control the speed of the DC motor when there is a position change of the encoder.

12. The low speed driving control method of claim 11, wherein the switching comprises determining a voltage V_{b} to control the DC motor by:
V_{b}=Vₚᵣₑᵥ+V_{cons}
where, Vₚᵣₑᵥ is a previous voltage of the DC motor, and V_{cons} is a voltage extracted from the voltage table.

13. A low speed driving control method for a DC motor, the method comprising:
receiving feedback of a current speed of the DC motor in accordance with a control period and controlling the speed of the DC motor accordingly;
controlling the speed of the DC motor according to a voltage table;
determining occurrence of a position change of an encoder connected with the DC motor according to a control period; and
if the position change does not occur, switching to receive the feedback of the current speed to control the speed of the DC motor, and if the position change occurs, controlling the speed of the DC motor according to a voltage table.

14. A low speed driving control device of a DC motor, comprising:
a first speed controller comprising a proportional-plus-integrate-plus-derivative (PID) controller for receiving feedback of the DC motor current speed in control periods, for generating a first control signal, a second control signal and a third control signal, and for parallel connecting the first, second and third control signals to determine a voltage to be applied to the DC motor; and
a second speed controller for controlling the speed of the DC motor according to a voltage table, wherein the voltage table comprises an increment constant when the DC motor rotates in a forward direction and a decrement constant when the DC motor rotates in a backward direction.

15. The low speed driving control device of claim 14, further comprising:
a switching controller for switching between the first speed controller and the second speed controller according to a position change of an encoder connected with the DC motor.

16. The low speed driving control device of claim 15, wherein the DC motor is driven by a voltage obtained by the first speed controller when the DC motor is connected with the first speed controller.

17. The low speed driving control device of claim 15, wherein the DC motor is driven by a voltage obtained by the second speed controller when the DC motor is connected with the second speed controller.

18. The low speed driving control device of claim 14, wherein the voltage table comprises a speed of the DC motor according to a fixed position count of each target speed.

19. The low speed driving control device of claim 18, wherein the switching controller increments the fixed position count from an initial value “0” when there is no change in the count of the encoder position information in the control periods, and wherein the switching controller initializes a current fixed position count to “0” when there is a change in the count of the encoder position information.
